(19) United States
(12) Patent Application Publication
(10) Pub. No.: US 2015/0213912 A1
(43) Pub. Date: Jul. 30, 2015

(54) POLYCAPILLARY LENS

(71) Applicant: HAMAMATSU PHOTONICS K.K., Hamamatsu-shi, Shizuoka (JP)

(72) Inventors: Takuya Sakai, Hamamatsu-shi (JP); Yutaro Suzuki, Hamamatsu-shi (JP)

(73) Assignee: HAMAMATSU PHOTONICS K.K., Hamamatsu-shi, Shizuoka (JP)

(21) Appl. No.: 14/427,411

(22) PCT Filed: Sep. 9, 2013
(86) PCT No.: PCT/JP2013/074269

§ 371 Date: Mar. 11, 2015

(30) Foreign Application Priority Data
Sep. 14, 2012 (JP) 2012-203199

(51) Int. Cl. G21K 1/06

(52) U.S. Cl. CPC G21K 1/067; G21K 2201/067

(57) ABSTRACT

A polycapillary lens has a plurality of capillaries, extending from one end face to the other end face and configured to guide radiation or a particle beam input into the one end face, to the other end face, and has a plurality of concentric areas A1, A2 in a plane intersecting with a guide direction of the radiation or the particle beam. In addition, an inside diameter La of the capillaries included in the area A1 is different from an inside diameter Lb of the capillaries included in the area A2.

### TECHNICAL FIELD

The present invention relates to a polycapillary lens.

### BACKGROUND ART

Patent Document 1 describes the polycapillary lens composed of a plurality of bundled hollow tubes. This polycapillary lens is configured to guide X-rays emitted from a point outside of an input end face or X-rays input in the form of a parallel beam, through the inside of each capillary to an output end face and to focus the X-rays at a point outside of the output end face. Or, this polycapillary lens guides X-rays emitted from a point outside of the input end face, through the inside of each capillary to the output end face and outputs the X-rays in the form of a parallel beam.

Patent Document 2 describes a capillary optical system for generating a high-intensity small-diameter X-ray beam. This system is equipped with an optical device consisting of a plurality of capillary tubes integrally formed by melting.

### CITATION LIST

### Patent Literature

Patent Document 1: Japanese Patent Application Laid-Open No. 2005-321246
Patent Document 2: Japanese Translation of PCT International Application No. H10-508947

### SUMMARY OF INVENTION

### Technical Problem

The polycapillary lenses are used in various applications, e.g., X-ray diffraction (XRD: X-ray Diffraction), and the polycapillary lenses may be required to have different characteristics depending upon applications. For example, in an application of attempting to input X-rays with an energy distribution in which energy is larger in the central region than in the peripheral region and to output X-rays with an even energy distribution, the polycapillary lens desirably has such a characteristic that X-ray transmittance is higher in the peripheral region than in the central region. In another application of attempting to simply make the total energy of output X-rays large, each capillary is desirably configured so as to make the X-ray transmittance large in each of the individual capillaries forming the polycapillary lens.

The present invention has been achieved in view of the above problem, and an object thereof is to provide a polycapillary lens capable of realizing a characteristic suitable for an application.

### Solution to Problem

In order to solve the above-described problem, a first polycapillary lens according to the present invention is a polycapillary lens having a plurality of capillaries extending from one end face to the other end face and configured to guide radiation or a particle beam input into the one end face, to the other end face, wherein in a plane intersecting with a guide direction of the radiation or the particle beam, there are a plurality of concentric areas different in inside diameter of the capillaries from each other.

Further, a second polycapillary lens according to the present invention is a polycapillary lens having a plurality of capillaries extending from one end face to the other end face and configured to guide radiation or a particle beam input into the one end face, to the other end face, wherein in a plane intersecting with a guide direction of the radiation or the particle beam, an inside diameter of the capillaries in a first area is different from an inside diameter of the capillaries in a second area surrounding the first area.

There are the polycapillary lenses of many shapes. Examples thereof include one configured to make radiation or a particle beam, input from a point radiation source into the one end face, into a parallel beam and to output the parallel beam from the other end face, one configured to make parallel radiation or a parallel particle beam, input into the one end face, into a focusing beam and to output the focusing beam from the other end face, one configured to make radiation or a particle beam, input from a point radiation source into the one end face, into a focusing beam and to output the focusing beam from the other end face, and so on. For realizing these actions, the plurality of capillaries forming the polycapillary lens are formed in such a manner that some capillaries extend linearly between the input end face and the output end face and that other capillaries are curved between the input end face and the output end face.

Concerning such polycapillary lenses, the present inventors found the following fact. Namely, in a linearly-extending capillary, the number of reflections of the radiation (or the particle beam) on the inner wall becomes larger with decrease in inside diameter of the capillary, so as to increase loss, thereby decreasing transmittance. FIG. 20 is a drawing conceptually showing the situation of the foregoing, wherein (a) in FIG. 20 shows a cross section along the guide direction of a capillary 110 with a large inside diameter, and (b) in FIG. 20 shows a cross section along the guide direction of a capillary 120 with a small inside diameter. As shown in these figures, when the radiation (or the particle beam) XR is incident at a certain fixed angle θa to the end face, reflection intervals G of the radiation (or the particle beam) XR become shorter and thus the number of reflections becomes larger, in the small-inside-diameter capillary 120 than in the large-inside-diameter capillary 110. Therefore, in the linearly-extending capillary, the loss of the radiation (or the particle beam) increases as the inside diameter becomes smaller.

On the other hand, in a curved capillary, the angle of incidence of the radiation (or the particle beam) to the inner wall becomes larger with increase in inside diameter, so as to increase the loss. FIG. 21 is a drawing conceptually showing the situation of the foregoing, wherein (a) in FIG. 21 shows a cross section along the guide direction of a capillary 130 with a large inside diameter, and (b) in FIG. 21 shows a cross section along the guide direction of a capillary 140 with a small inside diameter. As shown in these figures, when the radiation (or the particle beam) XR is incident at a certain fixed angle θb to the end face, the first reflection position F becomes farther from the input end face and thus the angle of incidence θc of the radiation (or the particle beam) XR to the inner wall becomes smaller, in the large-inside-diameter capillary 130 than in the small-inside-diameter capillary 140, so as to decrease reflectance. Therefore, in the curved capillary, the loss of the radiation (or the particle beam) increases as the inside diameter becomes larger, so as to lower the transmittance.

The aforementioned first polycapillary lens has the plurality of concentric areas different in inside diameter of the capillaries from each other, in the plane intersecting with the guide direction of the radiation or the particle beam. In the aforementioned second polycapillary lens, the inside diameter of the capillaries in the first area is different from the inside diameter of the capillaries in the second area surrounding the first area, in the plane intersecting with the guide direction of the radiation or the particle beam.

In this manner, the inside diameters of the capillaries are set different among the areas, whereby a level of the loss can be set for each of the areas. For example, in an area including linear capillaries, the inside diameter of the capillaries can be set large in a case where the loss is desirably small, or, the inside diameter of the capillaries can be set small in the case where the loss is desirably large. In an area including curved capillaries, the inside diameter of the capillaries can be set small in the case where the loss is desirably small, or, the inside diameter of the capillaries can be set large in the case where the loss is desirably large.

As explained above, the above-described first and second polycapillary lenses can realize the characteristics suitable for applications while the inside diameters of the capillaries are set different among the plurality of areas.

### Advantageous Effects of Invention

The polycapillary lenses according to the present invention can realize the characteristics suitable for applications.

### BRIEF DESCRIPTION OF DRAWINGS

FIG. 1 is a side view showing the polycapillary lens according to one embodiment.

FIG. 2 includes (a) a drawing showing a cross section of the polycapillary lens along the line II-II shown in FIG. 1, (b) a cross-sectional view showing an enlargement of area A1, and (c) a cross-sectional view showing an enlargement of area A2.

FIG. 3 is a drawing showing a cross-sectional structure of a preform used for manufacture of the polycapillary lens.

FIG. 4 is a drawing showing an enlargement of a part of the cross-sectional structure of the preform shown in FIG. 3.

FIG. 5 includes (a) a side view of the polycapillary lens, (b) a drawing showing an example of an intensity distribution of X-rays input into one end face, and (c) a drawing showing an example of an intensity distribution of X-rays output from the other end face.

FIG. 6 is a graph showing the result of comparison between intensity distributions of output X-rays from the polycapillary lens of one embodiment and the polycapillary lens of a comparative example with an even capillary inside diameter.

FIG. 7 includes (a) a drawing showing a cross section intersecting with an X-ray guide direction of the polycapillary lens according to a first modification example, (b) a cross-sectional view showing an enlargement of area A1, and (c) a cross-sectional view showing an enlargement of area A2.

FIG. 8 includes (a) a side view of the polycapillary lens according to the first modification example, (b) a drawing showing an example of an intensity distribution of X-rays input into one end face, and (c) a drawing showing an example of an intensity distribution of X-rays output from the other end face.

FIG. 9 is a side view showing the polycapillary lens according to a second modification example.

FIG. 10 includes (a) a side view of the polycapillary lens according to the second modification example, (b) a drawing showing an example of an intensity distribution of X-rays input into one end face, and (c) a drawing showing an example of an intensity distribution of X-rays output from the other end face.

FIG. 11 includes (a) a side view of the polycapillary lens according to the second modification example, (b) a drawing showing an example of an intensity distribution of X-rays input into one end face, and (c) a drawing showing an example of an intensity distribution of X-rays output from the other end face.

FIG. 12 is a side view showing the polycapillary lens according to a third modification example.

FIG. 13 includes (a) a side view of the polycapillary lens according to the third modification example, (b) a drawing showing an example of an intensity distribution of X-rays input into one end face, and (c) a drawing showing an example of an intensity distribution of X-rays output from the other end face.

FIG. 14 includes (a) a side view of the polycapillary lens according to the third modification example, (b) a drawing showing an example of an intensity distribution of X-rays input into one end face, and (c) a drawing showing an example of an intensity distribution of X-rays output from the other end face.

FIG. 15 is a drawing showing a cross-sectional structure of a preform used for manufacture of the polycapillary lens, as a fourth modification example.

FIG. 16 is a drawing showing an enlargement of a part of the cross-sectional structure of the preform shown in FIG. 15.

FIG. 17 is a drawing showing another form of the fourth modification example, which shows an enlargement of a part of a cross-sectional structure of a preform used for manufacture of the polycapillary lens.

FIG. 18 is a drawing showing a cross-sectional structure of a preform used for manufacture of the polycapillary lens, as a fifth modification example.

FIG. 19 is a drawing showing a cross-sectional structure of a preform used for manufacture of the polycapillary lens, as a fifth modification example.

FIG. 20 includes (a) a drawing showing a cross section along the guide direction of a capillary with a large inside diameter, and (b) a drawing showing a cross section along the guide direction of a capillary with a small inside diameter.

FIG. 21 includes (a) a drawing showing a cross section along the guide direction of a capillary with a large inside diameter, and (b) a drawing showing a cross section along the guide direction of a capillary with a small inside diameter.

### DESCRIPTION OF EMBODIMENTS

Hereinafter, embodiments of the polycapillary lens according to the present invention will be described in detail with reference to the accompanying drawings. In addition, in the description of the drawings, the same elements will be denoted by the same reference symbols, without redundant description.

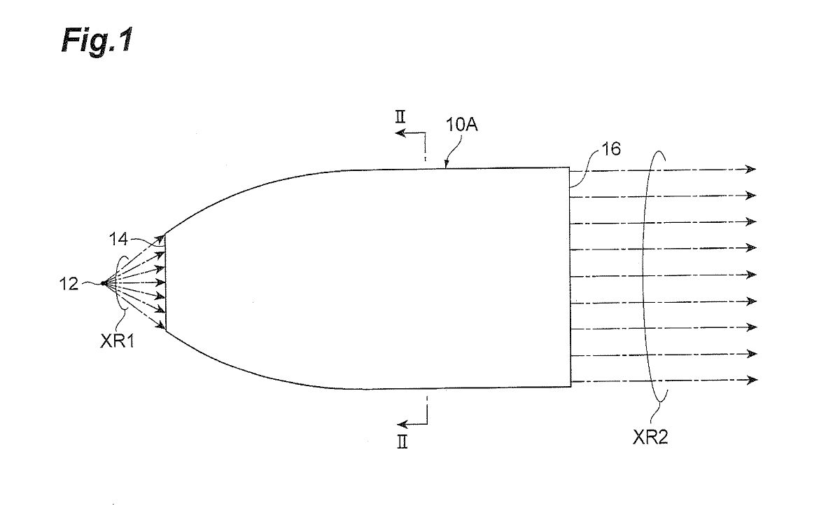

FIG. 1 is a side view showing the polycapillary lens (multi-capillary lens) 10A according to one embodiment of the present invention. FIG. 1 shows X-rays XR1 input into this polycapillary lens 10A and X-rays XR2 output from the polycapillary lens 10A, together. The polycapillary lens 10A is of a substantially cylindrical shape and a cross section perpendicular to its central axis is a circle centered on the central axis. This polycapillary lens 10A converts the X-rays XR1 input from a point X-ray source 12 into one end face 14, into parallel X-rays (X-rays XR2) and outputs the parallel X-rays XR2 from the other end face 16. For this purpose, the diameter of the polycapillary lens 10A gradually decreases toward the input end face 14.

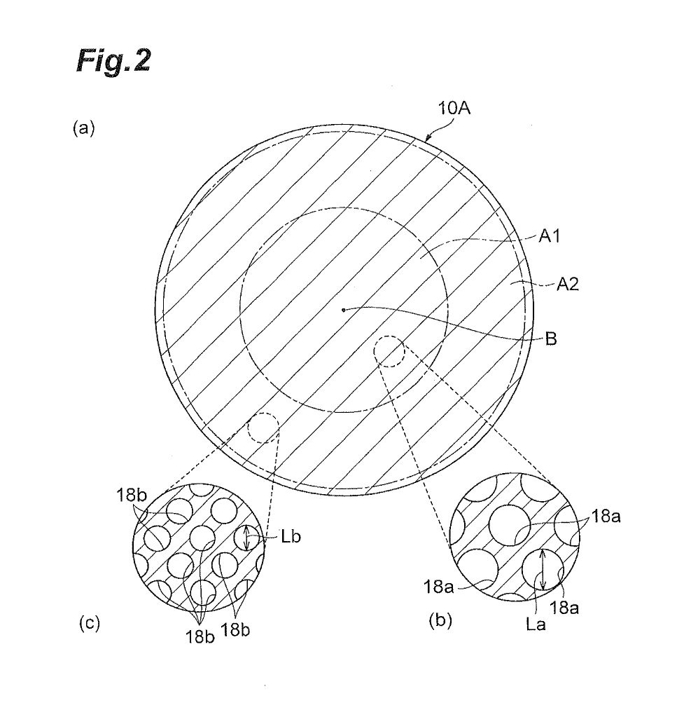

(a) in FIG. 2 shows a cross section of the polycapillary lens 10A along the line II-II shown in FIG. 1, i.e., a cross section intersecting with an X-ray guide direction of the polycapillary lens 10A. In more detail, this cross section is one perpendicular to the central axis B of the polycapillary lens 10A.

As shown in (a) in FIG. 2, this polycapillary lens 10A has a plurality of (two in the present embodiment) concentric areas A1, A2 in a plane intersecting with the X-ray guide direction. In other words, the polycapillary lens 10A has the first area (effective central region) A1 and the second area (peripheral region) A2 surrounding the first area A1, in the plane intersecting with the X-ray guide direction. The center common to these areas A1, A2 lies, for example, on the central axis B of the polycapillary lens 10A and coincides with the central axis of the guided X-ray beam. The diameter of the area A1 is, for example, half of the diameter of the area A2.

(b) in FIG. 2 is a cross-sectional view showing an enlargement of the area A1. (c) in FIG. 2 is a cross-sectional view showing an enlargement of the area A2. As shown in (b) in FIG. 2 and (c) in FIG. 2, the polycapillary lens 10A has a plurality of capillaries 18a in the area A1 and a plurality of capillaries 18b in the area A2. The plurality of capillaries 18a are two-dimensionally arranged in the area A1 in the plane intersecting with the X-ray guide direction. Similarly, the plurality of capillaries 18b are two-dimensionally arranged in the area A2 in the plane intersecting with the X-ray guide direction.

The capillaries 18a and 18b are holes extending from the input end face (one end face) 14 to the output end face (other end face) 16 of the polycapillary lens 10A and are formed through between these faces. The capillaries 18a and 18b guide the X-rays (input X-rays XR1) input into openings on the input end face 14 side through the interior thereof and output the parallel X-rays XR2 from openings on the output end face 16 side. The drawings show the capillaries 18a and 18b of the circular cross section but the cross-sectional shape of the capillaries 18a and 18b may be, for example, a regular polygon shape (e.g., a regular hexagon shape) or a regular polygon shape with corners rounded.

As described above, the cross-section diameter gradually decreases toward the input end face 14, in order to output the parallel X-rays XR2 from the X-rays XR1 input from the point X-ray source 12, in the polycapillary lens 10A of the present embodiment. Specifically, the capillaries 18a and 18b near the input end face 14 are inclined toward the center of the lens 10A so that extension lines of central axes of the capillaries 18a and 18b in the input end face 14 pass the X-ray source 12, in order to make the X-rays XR1 radiated from the point X-ray source 12 and gradually diverging, efficiently input into the lens. On the other hand, in order to output the parallel X-rays XR2, the central axes of the capillaries 18a and 18b in the output end face 16 are made parallel to the central axis of the lens 10A.

In order to make the X-rays suitably guided inside the capillaries 18a and 18b of the foregoing form, the capillaries 18a and 18b extend linearly on and near the central axis of the lens 10A and are curved with curvature increasing with distance from the central axis. Namely, the capillaries 18a included in the area A1 closer to the central axis are linear or slightly curved and the capillaries 18b included in the area A2 farther from the central axis are largely curved.

Furthermore, in the present embodiment, the inside diameter La of the capillaries 18a in the area A1 is different from the inside diameter Lb of the capillaries 18b in the area A2. For example, in the present embodiment, as shown in FIG. 2, the inside diameter La of the capillaries 18a in the area A1 closer to the central axis B is larger than the inside diameter Lb of the capillaries 18b in the area A2 farther from the central axis B. The inside diameter La has, for example, the size of double the inside diameter Lb and the difference between these inside diameter La and inside diameter Lb is sufficiently larger than the inside diameter difference made by so-called dimension error, unevenness of temperature distribution in a manufacture process, and so on.

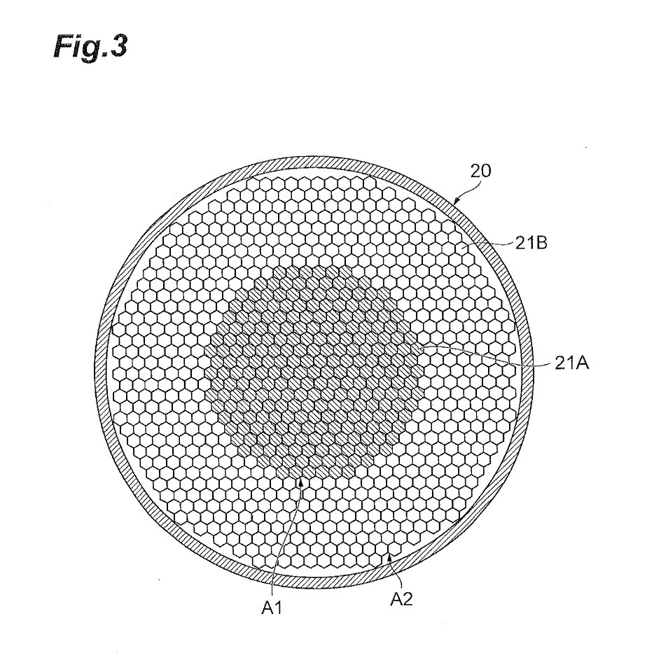

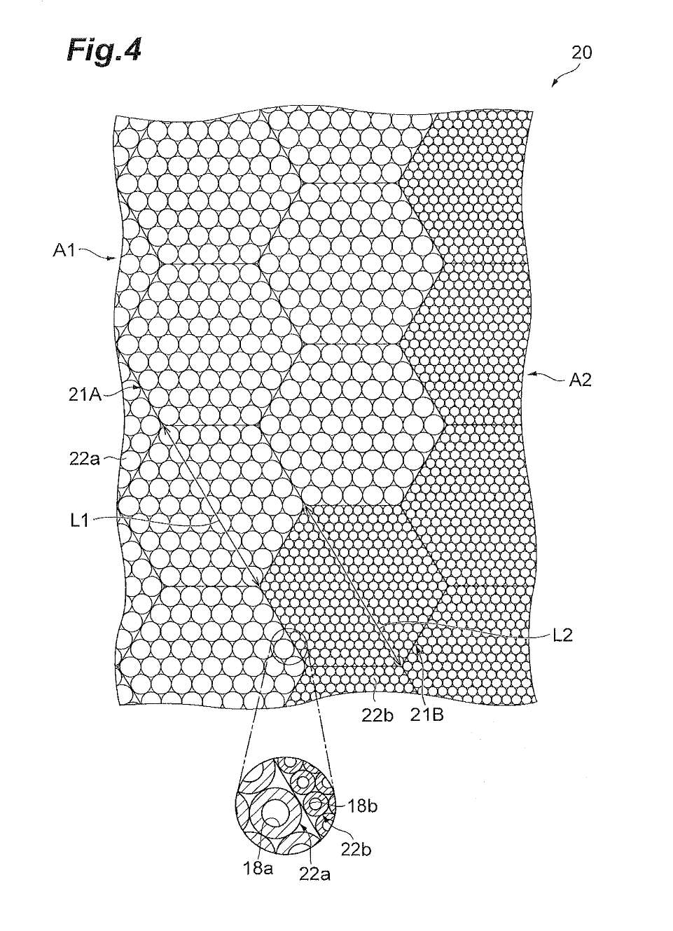

The polycapillary lens 10A as described above is manufactured by preparing a preform consisting of a bundle of capillary assemblies (hollow multi-fibers) each of which is composed of a plurality of bundled hollow tubes to form the capillaries 18a, 18b, and by extending the preform into taper shape under heat. FIG. 3 is a drawing showing a cross-sectional structure of the preform 20 used for manufacture of the polycapillary lens 10A and shows a cross section intersecting with the X-ray guide direction. FIG. 4 is a drawing showing an enlargement of a part of the cross-sectional structure of the preform 20 shown in FIG. 3. In FIG. 3, the hatched region near the the central axis B is a region to become the area A1 shown in (a) in FIG. 2. The unhatched region around it is a region to become the area A2 shown in (a) in FIG. 2.

As shown in FIG. 3, the preform 20 has a plurality of capillary assemblies 21A, 21B. In the area A1, the plurality of capillary assemblies 21A are two-dimensionally arranged in a plane intersecting with the X-ray guide direction. In the area A2, the plurality of capillary assemblies 21B are two-dimensionally arranged in the plane intersecting with the X-ray guide direction. As shown in FIG. 4, each capillary assembly 21A is composed of a bundle of a plurality of hollow tubes 22a to form the capillaries 18a, and each capillary assembly 21B is composed of a bundle of a plurality of hollow tubes 22b to form the capillaries 18b.

In the present embodiment, the cross-sectional shapes of the capillary assemblies 21A, 21B in the plane intersecting with the X-ray guide direction are regular hexagon and they are arranged in a honeycomb pattern such that neighboring capillary assemblies 21A (or 21B) are in contact with each other on one side of the regular hexagon. This form of the preform 20 is also inherited by the polycapillary lens 10A and the polycapillary lens 10A also has a plurality of capillary assemblies of the regular hexagon cross section.

As shown in FIG. 4, the inside diameter and outside diameter of the hollow tubes 22a forming the capillary assemblies 21A included in the area A1 are larger than the inside diameter and outside diameter of the hollow tubes 22b forming the capillary assemblies 21B included in the area A2. For this reason, the inside diameter of the capillaries 18a in the area A1 becomes larger than the inside diameter of the capillaries 18b in the area A2 as well, in the polycapillary lens 10A obtained after this preform 20 is heated and extended.

However, the cross-sectional shape and size of the capillary assemblies 21A in the plane intersecting with the X-ray guide direction are equal to the cross-sectional shape and size of the capillary assemblies 21B in the plane, as shown in FIG. 4. Specifically, the cross-sectional shapes of the capillary assemblies 21A, 21B both are regular hexagon and their outside diameters L1 and L2 are equal to each other.

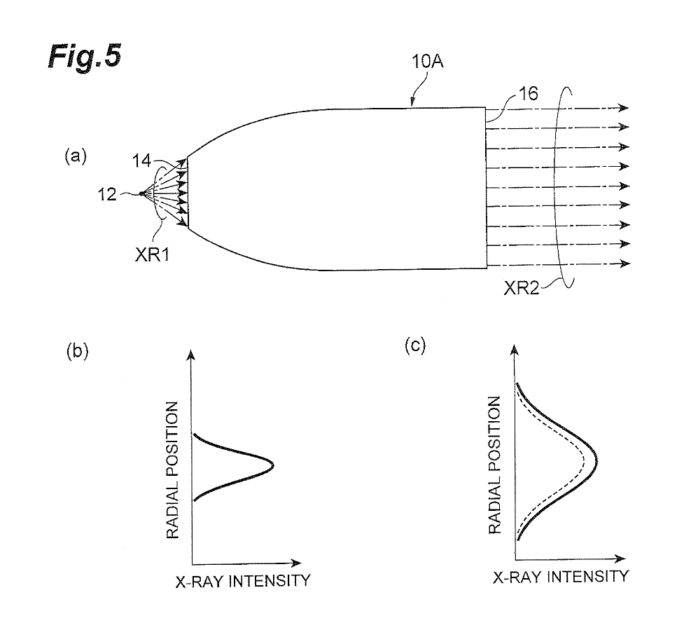

The below will describe the effect achieved by the polycapillary lens 10A of the present embodiment described above. FIG. 5 is a drawing for explaining the characteristic of the polycapillary lens 10A. (a) in FIG. 5 is a side view of the polycapillary lens 10A, (b) in FIG. 5 shows an example of the intensity distribution of the X-rays XR1 input into the end face 14, and (c) in FIG. 5 shows an example of the intensity distribution of the X-rays XR2 output from the end face 16. For comparison, (c) in FIG. 5 shows an intensity distribution assumed with the capillaries having an even inside diameter, by a dashed line.

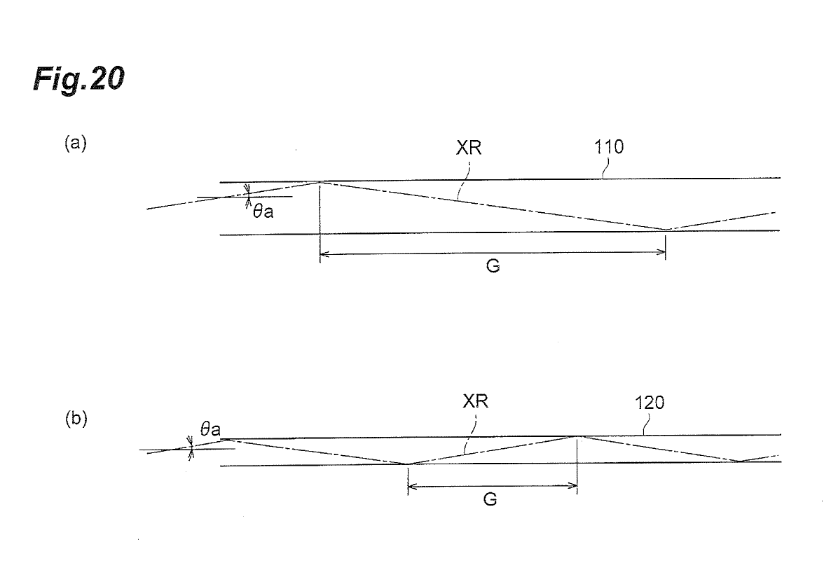

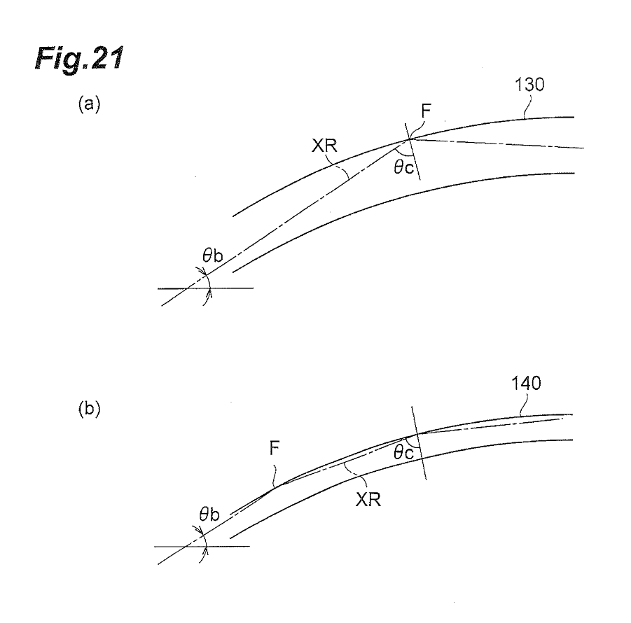

In this polycapillary lens 10A, the capillaries 18a included in the area A1 extend approximately linearly and the capillaries 18b included in the area A2 are largely curved. In this case, if the inside diameters of the capillaries in the areas A1, A2 were set equal to each other, the X-ray loss would increase in the area A1 because of the decreased inside diameter of the capillaries and the X-ray loss would increase in the area A2 because of the increased inside diameter of the capillaries, as having been described above with FIG. 20 and FIG. 21.

In contrast to it, the present embodiment is configured so that the inside diameter La of the capillaries 18a included in the area A1 is larger than the inside diameter Lb of the capillaries 18b included in the area A2. This configuration lengthens the X-ray reflection intervals in the capillaries 18a in the area A1 (cf. (a) in FIG. 20), so as to reduce the number of reflections, thereby decreasing the X-ray loss and thus increasing the transmittance. In the capillaries 18b included in the area A2, the first reflection position of input X-rays becomes closer to the end face 14 and thus the angles of incidence of X-rays to the inner walls become larger, so as to increase the reflectance (cf. (b) in FIG. 21), thereby reducing the X-ray loss and thus increasing the transmittance. Therefore, the intensity can be increased as a whole of the output X-rays XR2 and thus it becomes feasible, for example, to suitably carry out XRD or the like necessitating a large X-ray amount.

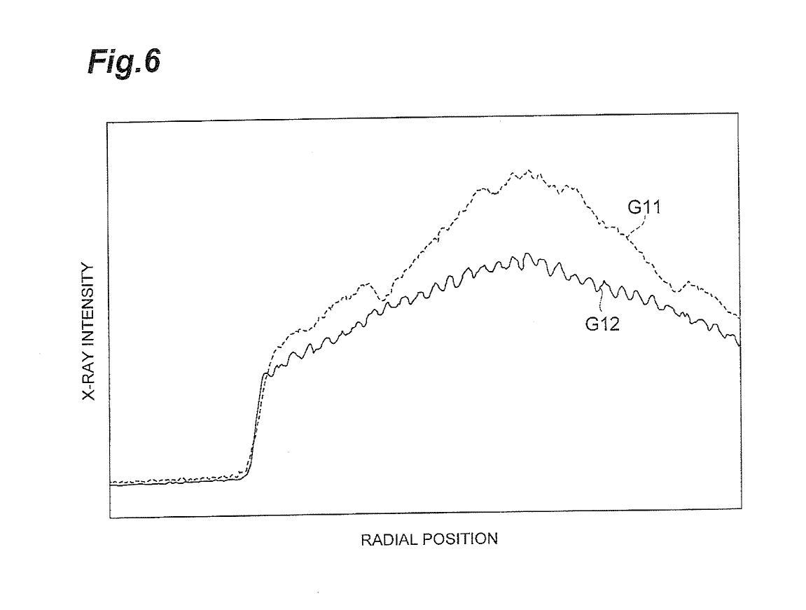

FIG. 6 is a graph showing the result of comparison between intensity distributions of output X-rays from the polycapillary lens 10A of the present embodiment and from the polycapillary lens of the comparative example with an even inside diameter of the capillaries. In FIG. 6, the horizontal axis represents radial position on the output end face and the vertical axis represents X-ray intensity. Graph G11 indicates the intensity distribution of the polycapillary lens 10A of the present embodiment and graph G12 indicates the intensity distribution of the polycapillary lens of the comparative example. The intensity distributions of input X-rays are equal to each other. The polycapillary lens of the comparative example was prepared in such a manner that the inside diameter of the capillaries at the preform stage was evenly 6 μm, whereas the polycapillary lens 10A of the present embodiment was prepared in such a manner that at the stage of the preform 20 the inside diameter La of the capillaries in the area A1 was 12 μm and the inside diameter Lb of the capillaries in the area A2 was 6 μm.

As shown in FIG. 6, it is seen that the intensities of output X-rays are higher in both of the areas A1 and A2 in the polycapillary lens 10A of the present embodiment than in the comparative example. Namely, the polycapillary lens 10A of the present embodiment can efficiently collimate the X-rays while reducing the X-ray loss.

The present embodiment is configured by making larger the capillary inside diameter La in the area A1 closer to the central axis B and by making smaller the capillary inside diameter Lb in the area A2 farther from the central axis B, but the size relation of the capillary inside diameters between the areas may be appropriately set according to an application or a required characteristic of the polycapillary lens. For example, in a case where the loss is desired to increase in the area A1 including the linear capillaries 18a, it can be achieved by making the inside diameter La of the capillaries 18a in the area A1 smaller. In a case where the loss is desired to increase in the area A2 including the curved capillaries 18b, it can be achieved by making the inside diameter Lb of the capillaries 18b larger. In this manner, lens characteristics suitable for applications can be realized by making the inside diameters of the capillaries in the respective areas different from each other.

The total-reflection critical angle in reflection of X-rays on the inner walls of the capillaries 18a, 18b (note that the total-reflection critical angle herein refers to an angle between a tangent line to an inner wall surface along the guide direction and an X-ray incident on the inner wall surface, which is the largest angle at which the X-ray can be totally reflected) becomes smaller with increase in energy of X-rays and larger with decrease in energy of X-rays. The total-reflection critical angle also depends upon the density of the constituent material of the polycapillary lens 10A and the total-reflection critical angle increases with increase in density. For example, when the constituent material of the polycapillary lens 10A is borosilicate glass, the total-reflection critical angle with the X-ray energy of 8 keV is approximately 0.22° and the total-reflection critical angle with 20 keV is 0.08°.

Therefore, with the X-ray energy being high, the total-reflection critical angle is small and thus the inside diameter Lb of the capillaries 18b in the area A2 (peripheral region) is preferably small. This can increase the angle of incidence so as to effectively reduce the loss. On the other hand, with the X-ray energy being low, the total-reflection critical angle is large and thus the inside diameter Lb of the capillaries 18b in the area A2 (peripheral region) is preferably large. This can decrease the number of reflections so as to effectively reduce the loss. In the present embodiment, as described above, the appropriate capillary inside diameter is selected according to the X-ray energy, whereby the intensity of the whole X-rays output from the polycapillary lens 10A can be enhanced.

The cross-sectional shapes and sizes of the capillary assemblies are preferably equal to each other between the neighboring areas A1, A2, as in the present embodiment. This allows the capillary assemblies 21A, 21B to also be continuously arranged in a boundary region between neighboring areas A1, A2 where the inside diameters of the capillaries are different from each other, as inside each area A1, A2. Therefore, the polycapillary lens 10A can be suitably manufactured while suppressing occurrence of a gap in the boundary region. The cross-sectional shapes of the capillary assemblies 21A, 21B are preferably regular hexagon as in the present embodiment. This can facilitate gapless dense arrangement of the capillary assemblies 21A, 21B.

### First Modification Example

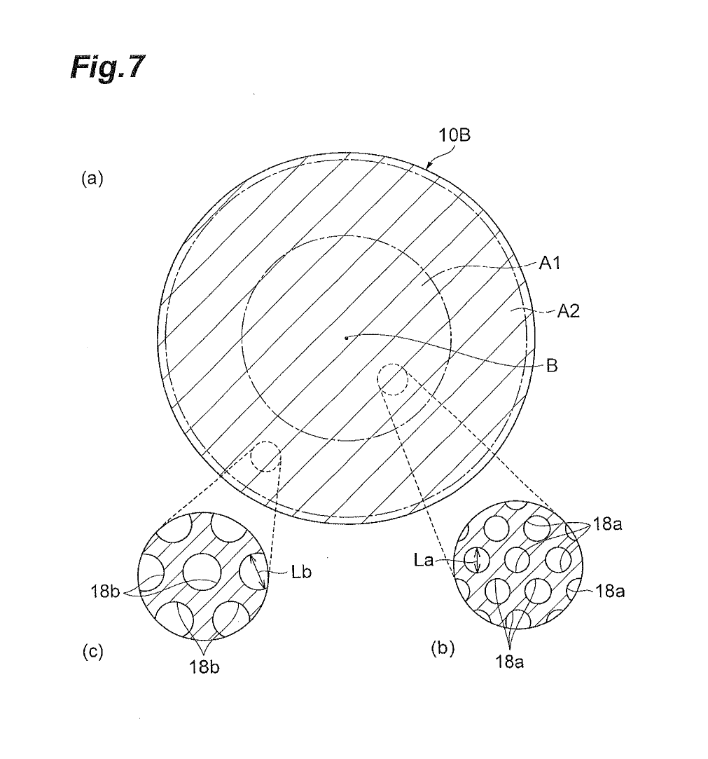

(a) in FIG. 7 is a drawing showing a cross section intersecting with the X-ray guide direction of the polycapillary lens 10B according to the first modification example. This polycapillary lens 10B is different in the size relation between the inside diameter La of the capillaries 18a included in the area A1 and the inside diameter Lb of the capillaries 18b included in the area A2, from the polycapillary lens 10A of the above embodiment. In the present modification example, the inside diameter Lb is larger than the inside diameter La, as shown in (b) in FIG. 7 and (c) in FIG. 7. The other configuration is the same as in the above embodiment.

For manufacturing this polycapillary lens 10B, the preform 20 shown in FIG. 3 and FIG. 4 may be modified in such a manner that the inside diameter and outside diameter of the hollow tubes 22b of the capillary assemblies 21B included in the area A2 are set larger than the inside diameter and outside diameter of the hollow tubes 22a of the capillary assemblies 21A included in the area A1.

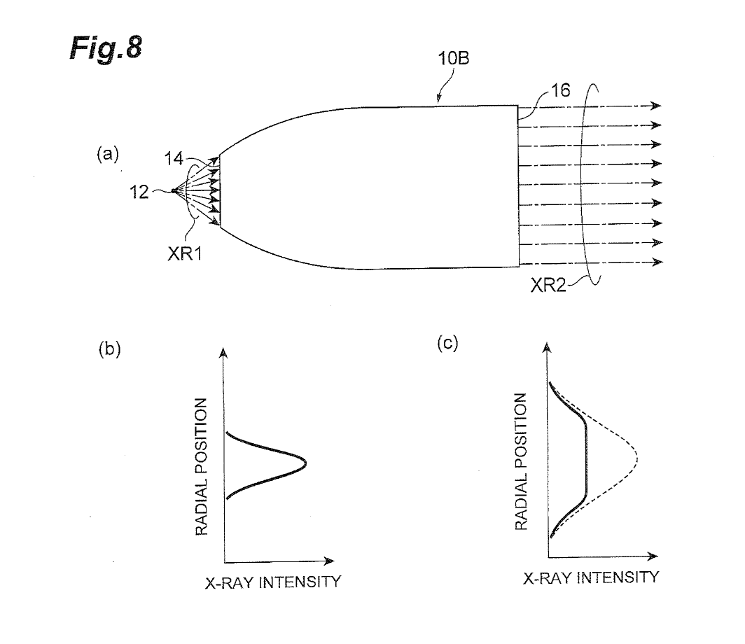

FIG. 8 is a drawing for explaining the characteristic of the polycapillary lens 10B. (a) in FIG. 8 is a side view of the polycapillary lens 10B, (b) in FIG. 8 shows an example of the intensity distribution of the X-rays XR1 input into the end face 14, and (c) in FIG. 8 shows an example of the intensity distribution of the X-rays XR2 output from the end face 16. For comparison, (c) in FIG. 8 shows an intensity distribution assumed with the capillaries having an even inside diameter, by a dashed line.

In this polycapillary lens 10B, the inside diameter La of the capillaries 18a included in the area A1 closer to the central axis B is made smaller. This shortens the X-ray reflection intervals in the capillaries 18a in the area A1 (cf. (b) in FIG. 20), so as to increase the number of reflections, thereby increasing the X-ray loss. Therefore, as shown in (c) in FIG. 8, the intensity is lowered near the central axis of the output X-rays XR2, whereby the intensity distribution can be made closer to an even one. This polycapillary lens 10B is suitably used, for example, in a case where an XRD sample is desired to be evenly irradiated with X-rays.

### Second Modification Example

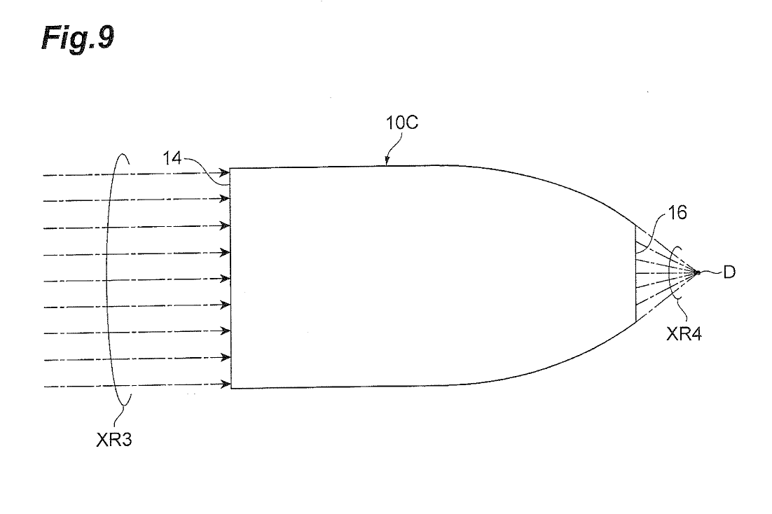

FIG. 9 is a side view showing the polycapillary lens 10C according to the second modification example. FIG. 9 shows X-rays XR3 input into this polycapillary lens 10C and X-rays XR4 output from the polycapillary lens 10C, together. The polycapillary lens 10C is of a substantially cylindrical shape and a cross section perpendicular to its central axis is a circle centered on the central axis. This polycapillary lens 10C has the same cross-sectional structure as that shown in FIG. 2 and has the concentric areas A1, A2 in the plane intersecting with the X-ray guide direction.

This polycapillary lens 10C converts the parallel X-rays XR3 input into the one end face 14, into the focusing X-rays XR4 converging toward a focal point D, and outputs the focusing X-rays XR4 from the other end face 16. For this purpose, the diameter of the polycapillary lens 10C gradually decreases toward the output end face 16.

Specifically, in order to make the parallel X-rays XR3 efficiently incident, extending directions of the capillaries 18a and 18b near the input end face 14 are set parallel to the central axis of the polycapillary lens 10C so that the extension lines of the central axes of the capillaries 18a and 18b in the input end face 14 pass the X-ray source 12. On the other hand, in order to converge the X-rays XR4 toward the focal point D, the capillaries 18a and 18b near the output end face 16 are inclined toward the central axis of the polycapillary lens 10C so that the extension lines of the central axes of the capillaries 18a and 18b in the output end face 16 pass the focal point D.

For suitably guiding the X-rays inside the capillaries 18a and 18b of this form, the capillaries 18a and 18b extend linearly on and near the central axis of the polycapillary lens 10C and are curved with curvature increasing with distance from the central axis of the polycapillary lens 10C. Namely, the capillaries 18a included in the area A1 (cf. FIG. 2) closer to the central axis of the polycapillary lens 10C are linear or slightly curved, while the capillaries 18b included in the area A2 (cf. FIG. 2) farther from the central axis of the polycapillary lens 10C are largely curved.

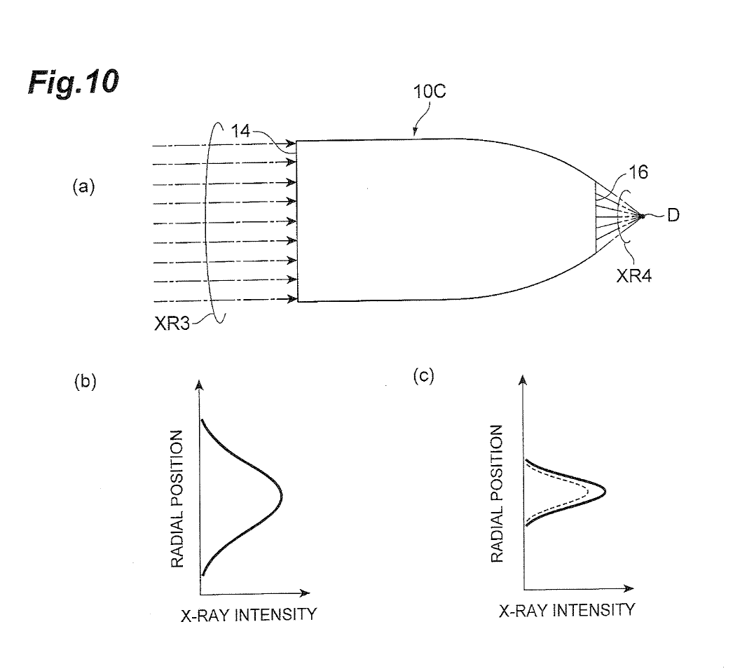

FIG. 10 is a drawing for explaining the characteristic of the polycapillary lens 10C, in the case where the inside diameter. La of the capillaries 18a included in the area A1 is larger than the inside diameter Lb of the capillaries 18b included in the area A2. (a) in FIG. 10 is a side view of the polycapillary lens 10C, (b) in FIG. 10 shows an example of the intensity distribution of the X-rays XR3 input into the end face 14, and (c) in FIG. 10 shows an example of the intensity distribution of the X-rays XR4 output from the end face 16. For comparison, (c) in FIG. 10 shows an intensity distribution assumed with the capillaries having an even inside diameter, by a dashed line.

In this polycapillary lens 10C, as in the above embodiment, the inside diameter La of the capillaries 18a in the area A1 closer to the central axis of the polycapillary lens 10C is larger than the inside diameter Lb of the capillaries 18b in the area A2 around it. This configuration lengthens the X-ray reflection intervals in the capillaries 18a in the area A1 (cf. (a) in FIG. 20), so as to reduce the number of reflections, thereby decreasing the X-ray loss. Therefore, the intensity can be increased as a whole of the output X-rays XR4 and thus it becomes feasible, for example, to suitably carry out XRD or the like necessitating a large X-ray amount.

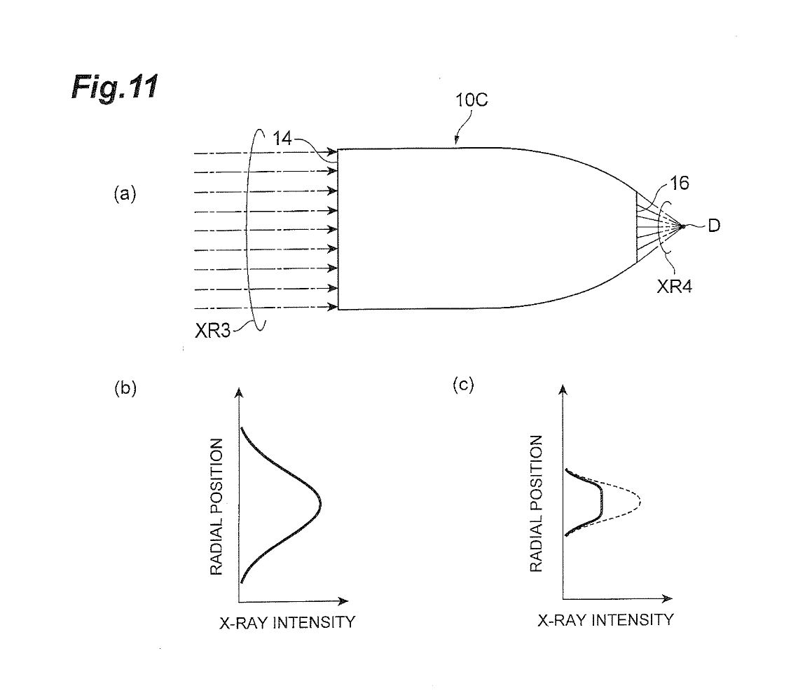

FIG. 11 is a drawing for explaining the characteristic of the polycapillary lens 10C, in the case where the inside diameter La of the capillaries 18a included in the area A1 is smaller than the inside diameter Lb of the capillaries 18b included in the area A2. In this polycapillary lens 10C, the X-ray reflection intervals become shorter in the capillaries 18a in the area A1 (cf. (b) in FIG. 20), so as to increase the number of reflections, thereby increasing the X-ray loss. Therefore, as shown in (c) in FIG. 11, the intensity of the output X-rays XR4 is lowered near the central axis of the polycapillary lens 10C, whereby the intensity distribution can be made closer to an even one. This polycapillary lens 10C is suitably used, for example, in a case where X-rays generated from a sample surface are desired to converge with even intensity.

### Third Modification Example

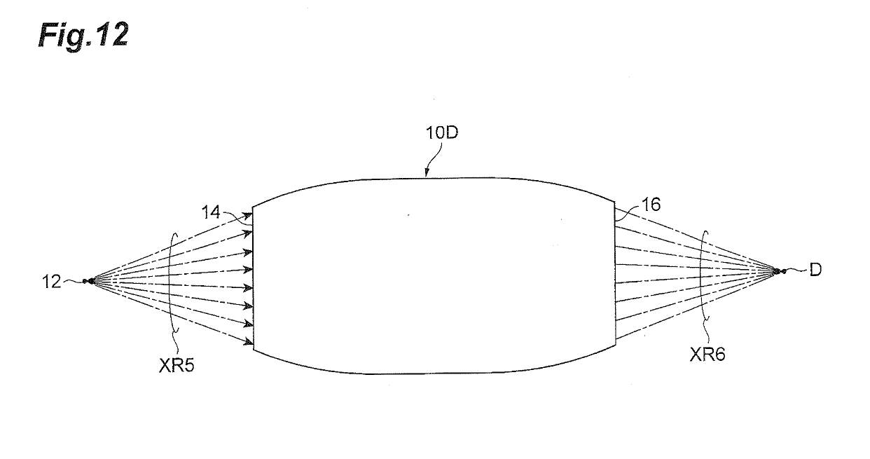

FIG. 12 is a side view showing the polycapillary lens 10D according to the third modification example. FIG. 12 shows X-rays XR5 input into this polycapillary lens 10D and X-rays XR6 output from the polycapillary lens 10D, together. The polycapillary lens 10D is of a substantially cylindrical shape and a cross section perpendicular to its central axis is a circle centered on the central axis. This polycapillary lens 10D has the same cross-sectional structure as that shown in FIG. 2 and has the concentric areas A1, A2 in the plane intersecting with the X-ray guide direction.

This polycapillary lens 10D converts the X-rays XR5 input from the point X-ray source 12 into the one end face 14, into the focusing X-rays XR6 converging toward the focal point D, and outputs the focusing X-rays XR6 from the other end face 16. For this purpose, the diameter of the polycapillary lens 10D gradually decreases from the central part in the central axis direction toward the input end face 14 and gradually decreases from the central part in the central axis direction toward the output end face 16.

Specifically, in order to make the X-rays XR5 radiated from the point X-ray source 12 and gradually diverging, efficiently incident, the capillaries 18a and 18b near the input end face 14 are inclined toward the central axis of the polycapillary lens 10D so that the extension lines of the central axes of the capillaries 18a and 18b in the input end face 14 pass the X-ray source 12. On the other hand, in order to converge the X-rays XR6 toward the focal point D, the capillaries 18a and 18b near the output end face 16 are inclined toward the central axis of the polycapillary lens 10D so that the extension lines of the central axes of the capillaries 18a and 18b in the output end face 16 pass the focal point D.

For suitably guiding the X-rays inside the capillaries 18a and 18b of this form, the capillaries 18a and 18b extend linearly on and near the central axis of the polycapillary lens 10D and are curved with curvature increasing with distance from the central axis of the polycapillary lens 10D. Namely, the capillaries 18a included in the area A1 closer to the central axis of the polycapillary lens 10D are linear or slightly curved, while the capillaries 18b included in the area A2 farther from the central axis of the polycapillary lens 10D are largely curved.

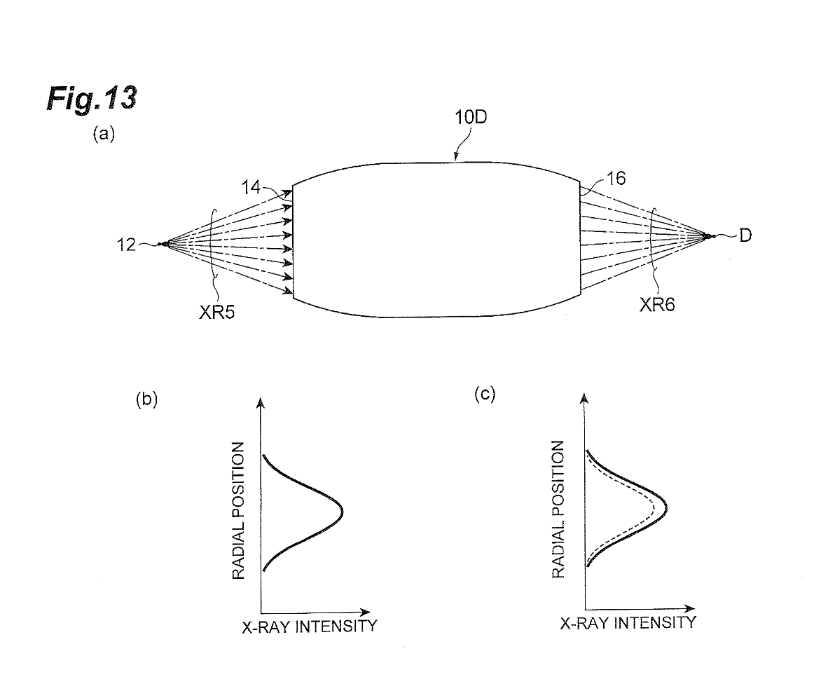

FIG. 13 is a drawing for explaining the characteristic of the polycapillary lens 10D, in the case where the inside diameter La of the capillaries 18a included in the area A1 is larger than the inside diameter Lb of the capillaries 18b included in the area A2. (a) in FIG. 13 is a side view of the polycapillary lens 10D, (b) in FIG. 13 shows an example of the intensity distribution of the X-rays XR5 input into the end face 14, and (c) in FIG. 13 shows an example of the intensity distribution of the X-rays XR6 output from the end face 16. For comparison, (c) in FIG. 13 shows an intensity distribution assumed with the capillaries having an even inside diameter, by a dashed line.

In this polycapillary lens 10D, as in the above embodiment, the inside diameter La of the capillaries 18a in the area A1 closer to the central axis B is larger than the inside diameter Lb of the capillaries 18b in the area A2 around it. Therefore, the X-ray reflection intervals become longer in the capillaries 18a in the area A1 (cf. (a) in FIG. 20), so as to reduce the number of reflections, thereby decreasing the X-ray loss. In the capillaries 18b included in the area A2, the first reflection position of the input X-rays XR5 becomes closer to the end face 14 and thus the angles of incidence of X-rays to the inner walls become larger, so as to increase the reflectance (cf. (b) in FIG. 21), thereby decreasing the X-ray loss. Therefore, the intensity can be increased as a whole of the output X-rays XR6 and thus it becomes feasible, for example, to suitably carry out XRD or the like necessitating a large X-ray amount.

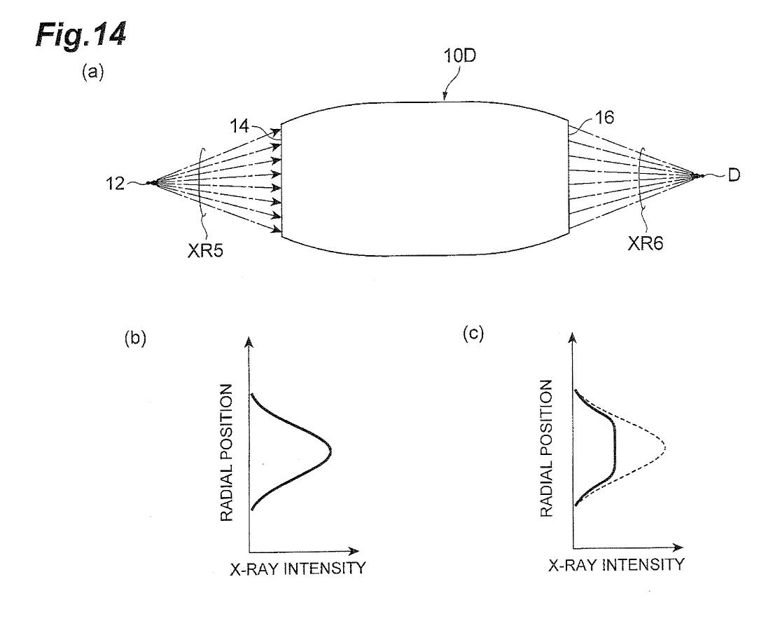

FIG. 14 is a drawing for explaining the characteristic of the polycapillary lens 10D, in the case where the inside diameter La of the capillaries 18a included in the area A1 is smaller than the inside diameter Lb of the capillaries 18b included in the area A2. In this polycapillary lens 10D, the X-ray reflection intervals become shorter in the capillaries 18a in the area A1 (cf. (b) in FIG. 20), so as to increase the number of reflections, thereby increasing the X-ray loss. Therefore, as shown in (c) in FIG. 14, the intensity of the output X-rays XR6 is lowered near the central axis of the polycapillary lens 10D, whereby the intensity distribution can be made closer to an even one. This polycapillary lens 10D is suitably used, for example, in a case where X-rays generated from a point of a sample are desired to converge with even intensity.

### Fourth Modification Example

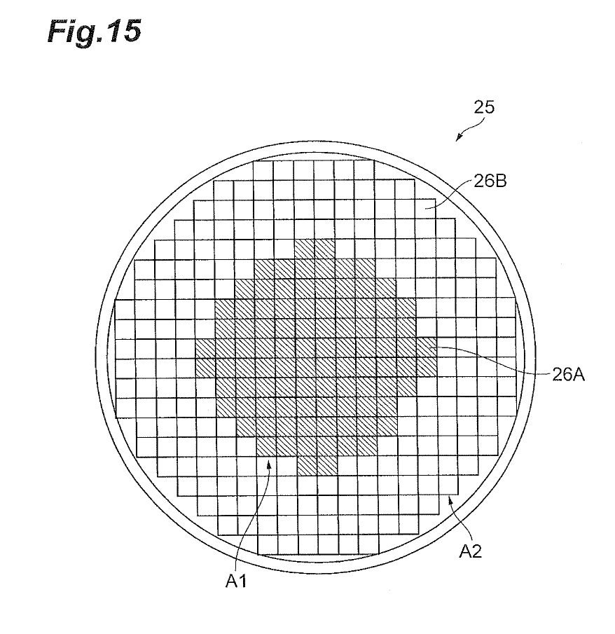

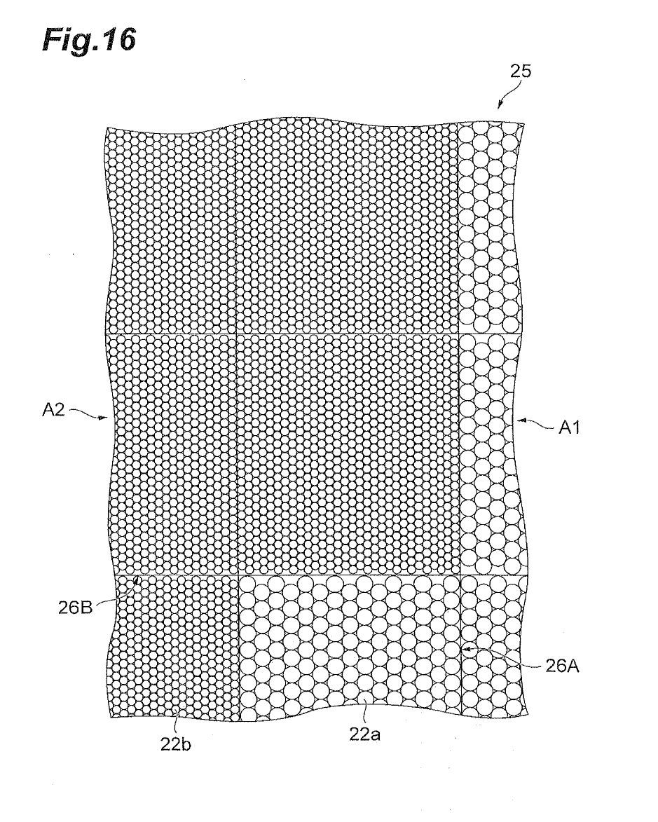

FIG. 15 is a drawing showing a cross-sectional structure of a preform 25 used for manufacture of the polycapillary lens, as a fourth modification example, and shows a cross section intersecting with the X-ray guide direction. FIG. 16 is a drawing showing an enlargement of a part of the cross-sectional structure of the preform 25 shown in FIG. 15.

As shown in FIG. 15, the preform 25 has a plurality of capillary assemblies 26A, 26B. The plurality of capillary assemblies 26A are two-dimensionally arranged in vertical and horizontal directions in the area A1 in a plane intersecting with the X-ray guide direction. The plurality of capillary assemblies 26B are two-dimensionally arranged in vertical and horizontal directions in the area A2 in the plane intersecting with the X-ray guide direction. As shown in FIG. 16, each capillary assembly 26A is composed of a bundle of a plurality of hollow tubes 22a to form the capillaries 18a (cf. FIG. 4), and each capillary assembly 26B is composed of a bundle of a plurality of hollow tubes 22b to form the capillaries 18b (cf. FIG. 4).

In the present embodiment, the cross-sectional shapes of the capillary assemblies 26A, 26B in the plane intersecting with the X-ray guide direction are square and they are arranged in a pattern such that neighboring capillary assemblies 26A (or 26B) are in contact with each other on one side of the square. This form of the preform 25 is also inherited by the polycapillary lens and the polycapillary lens also has a plurality of capillary assemblies of the square cross section.

In FIG. 15, the hatched region near the center is a region to become the area A1. The unhatched region around it is a region to become the area A2. In an example, the inside diameter and outside diameter of the hollow tubes 22a forming the capillary assemblies 26A included in the area A1 are larger (or smaller) than the inside diameter and outside diameter of the hollow tubes 22b forming the capillary assemblies 26B included in the area A2. For this reason, the inside diameter of the capillaries 18a in the area A1 becomes larger (or smaller) than the inside diameter of the capillaries 18b in the area A2 as well, in the polycapillary lens obtained after this preform 25 is heated and extended.

The cross-sectional shape and size of the capillary assemblies 26A in the area A1 in the plane intersecting with the X-ray guide direction are equal to the cross-sectional shape and size of the capillary assemblies 26B in the area A2 in the plane, as shown in FIG. 16. Specifically, the cross-sectional shapes of the capillary assemblies 26A, 26B both are square and the lengths of their respective sides are equal to each other.

As in the present modification example, the cross-sectional shapes of the capillary assemblies may be square and the capillary assemblies 26A, 26B of this shape can also be densely arranged without gap. When the cross-sectional shapes and sizes of the capillary assemblies 26A, 26B are equal to each other as in the present modification example, the capillary assemblies 26A, 26B can also be continuously arranged in the boundary region between neighboring areas A1, A2 in the same manner as inside each area A1, A2. Therefore, the polycapillary lens can be suitably manufactured while suppressing occurrence of a gap in the boundary region.

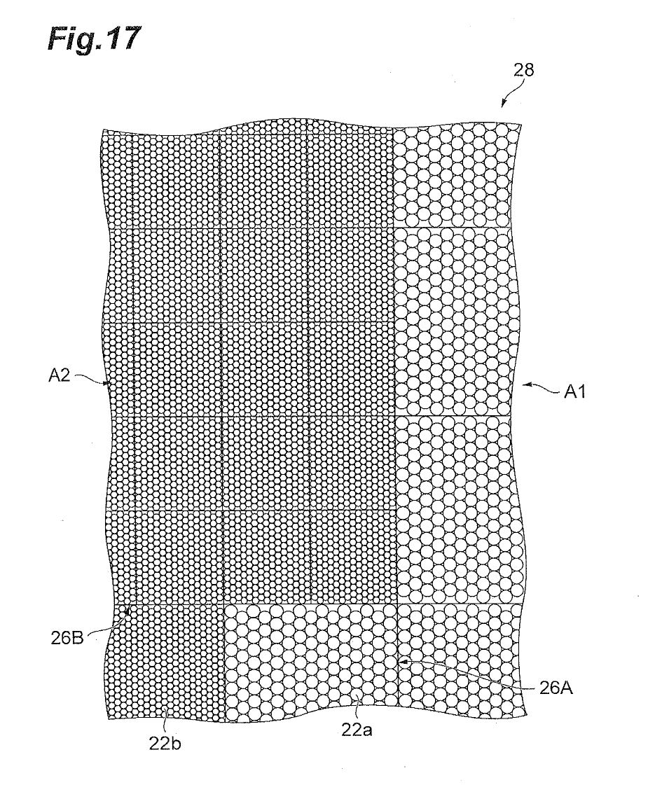

FIG. 17 is a drawing showing another form of the present modification example and shows an enlargement of a part of a cross-sectional structure of a preform 28 used for manufacture of the polycapillary lens. This preform 28 is different in the sizes of the capillary assemblies in the areas A1, A2 from the preform 25 shown in FIG. 16. Namely, in the preform 28, the size of each side of the capillary assemblies 26A in the area A1 is different from the size of each side of the capillary assemblies 26B in the area A2 and the size of each side of the capillary assemblies 26A is, for example, twice larger than the size of each side of the capillary assemblies 26B. The configuration of the capillary assemblies 26A, 26B other than the sizes is the same as that shown in FIG. 15 and FIG. 16.

When the cross-sectional shapes of the capillary assemblies are square as in the present modification example, the sizes of the capillary assemblies in the two neighboring areas A1, A2 may be different from each other, as shown in FIG. 17. In such case, the capillary assemblies can also be continuously arranged in the boundary region between the neighboring areas A1, A2 and thus occurrence of a gap can be suppressed in the boundary region.

### Fifth Modification Example

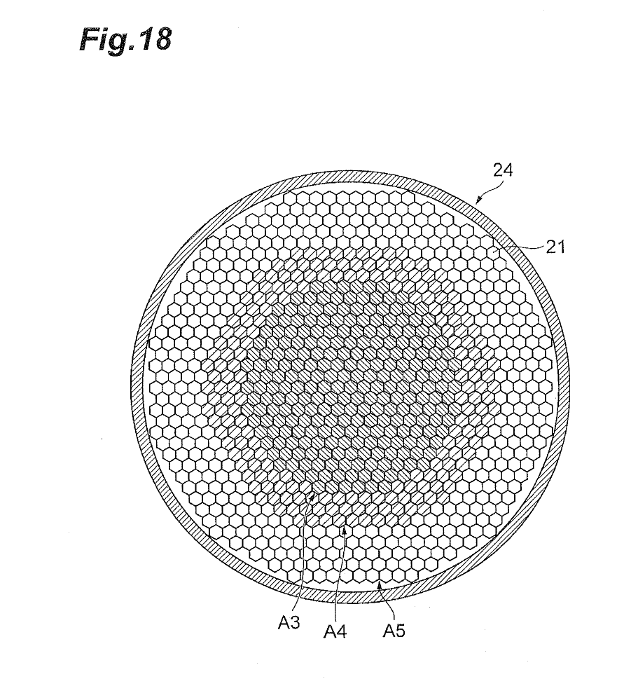

FIG. 18 is a drawing showing a cross-sectional structure of a preform 24 used for manufacture of the polycapillary lens, as a fifth modification example. As shown in FIG. 18, the preform 24 has a plurality of capillary assemblies 21. These capillary assemblies 21 are members of a regular hexagon sectional shape composed of a plurality of bundled hollow tubes to form the capillaries, as in the foregoing embodiment, and are arranged in a honeycomb pattern in the plane intersecting with the X-ray guide direction.

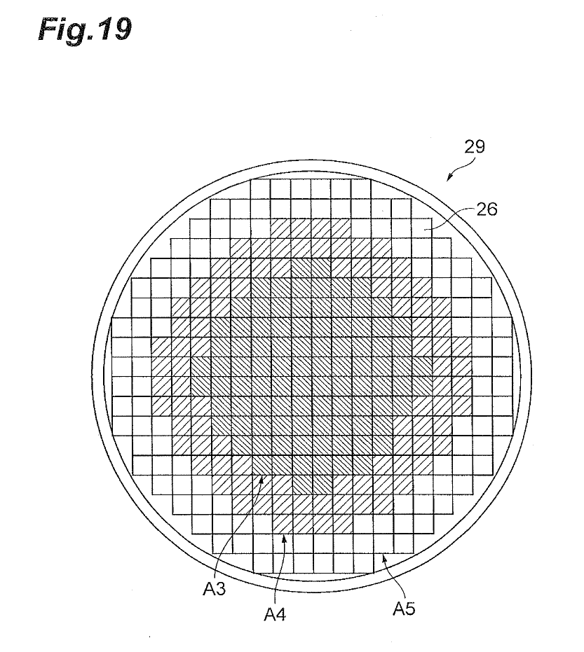

FIG. 19 is a drawing showing a cross-sectional structure of a preform 29 used for manufacture of the polycapillary lens. As shown in FIG. 19, the preform 29 has a plurality of capillary assemblies 26. These capillary assemblies 26 are members of a square sectional shape composed of a plurality of bundled hollow tubes to form the capillaries, as in the foregoing fourth modification example, and are arranged vertically and horizontally in the plane intersecting with the X-ray guide direction.

The preform 24 shown in FIG. 18 and the preform 29 shown in FIG. 19 have three concentric areas A3 to A5 in the cross section intersecting with the X-ray guide direction. In FIG. 18 and FIG. 19, the area A3 is a densely hatched region near the center, the area A4 a coarsely hatched region around it, and the area A5 an unhatched region further around it.

Therefore, the polycapillary lenses manufactured from these preforms 24, 29 also have three concentric areas corresponding to the areas A3 to A5, in the cross section intersecting with the X-ray guide direction. In other words, the polycapillary lenses manufactured from the preforms 24, 29 have a first area, a second area surrounding the first area, and a third area surrounding the second area, in the plane intersecting with the X-ray guide direction. The center common to these areas lies, for example, on the central axis of the polycapillary lens and coincides with the central axis of the guided X-ray beam.

In an example, the inside diameter and outside diameter of the hollow tubes forming the capillary assemblies 21, 26 are the largest in the area A3 and the smallest in the area A5. This makes the inside diameter of the capillaries also the largest in the area A3 and the inside diameter of the capillaries the smallest in the area A5, in the polycapillary lenses made after these preforms 24, 29 are heated and extended. In this manner, the inside diameter of the capillaries is larger in the area closer to the central axis of the polycapillary lens, whereby the X-ray reflection intervals become longer in the capillaries near the central axis of the polycapillary lens, so as to reduce the number of reflections, thereby decreasing the X-ray loss.

In another example, the inside diameter and outside diameter of the hollow tubes forming the capillary assemblies 21, 26 are the largest in the area A5 and the smallest in the area A3. This makes the inside diameter of the capillaries also the largest in the area A5 and the inside diameter of the capillaries the smallest in the area A3, in the polycapillary lenses made after these preforms 24, 29 are heated and extended. In this manner, the inside diameter of the capillaries is smaller in the area closer to the central axis of the polycapillary lens, whereby the X-ray reflection intervals become shorter in the capillaries near the central axis, so as to increase the number of reflections, thereby increasing the X-ray loss. Therefore, the intensity distribution can be made closer to an even one while decreasing the intensity of output X-rays in the vicinity of the central axis of the polycapillary lens.

The polycapillary lenses according to the present invention do not have to be limited to the above-described embodiments, but can be modified in other various ways. For example, in the above embodiment and each modification example, the cross-sectional shapes of the capillary assemblies are described as regular hexagon and square as examples, but the cross-sectional shapes of the capillary assemblies do not have to be limited to these. Further, in the above embodiment and each modification example, the inside diameters of the capillaries in the two (or three) areas are different in the plane intersecting with the X-ray guide direction, but the capillary inside diameters may be arranged as different among four or more areas.

In the above embodiment and each modification example, the guide object by the polycapillary lens is described as X-rays as an example, but the guide object by the polycapillary lens of the present invention may be other radiation such as gamma rays, or, a particle beam such as charged particles or neutron rays.

The first polycapillary lens according to the above embodiment is the polycapillary lens having the plurality of capillaries extending from one end face to the other end face and configured to guide the radiation or the particle beam input into the one end face, to the other end face, which has the configuration wherein in the plane intersecting with the guide direction of the radiation or the particle beam, there are the plurality of concentric areas different in inside diameter of the capillaries from each other.

The second polycapillary lens according to the above embodiment is the polycapillary lens having the plurality of capillaries extending from one end face to the other end face and configured to guide the radiation or the particle beam input into the one end face, to the other end face, which has the configuration wherein in the plane intersecting with the guide direction of the radiation or the particle beam, the inside diameter of the capillaries in the first area is different from the inside diameter of the capillaries in the second area surrounding the first area.

The foregoing polycapillary lens may be configured such that the polycapillary lens has the plurality of capillary assemblies each of which includes a plurality of bundled hollow tubes forming the respective capillaries and which are two-dimensionally arranged in the plane, and the cross-sectional shapes and sizes of the capillary assemblies in the plane are equal to each other between at least two neighboring areas out of the plurality of areas.

This allows the capillary assemblies to be continuously arranged in the boundary region between the neighboring areas different in inside diameter of the capillaries from each other, as inside each area, whereby the above polycapillary lens can be suitably manufactured while suppressing occurrence of a gap in the boundary region.

In this case, the cross-sectional shapes of the capillary assemblies in the plane are preferably regular hexagon or square. This facilitates gapless dense arrangement of the capillary assemblies.

In the foregoing polycapillary lens, the inside diameter of the capillaries may be made larger in the area closer to the center of the polycapillary lens. Or, in the foregoing polycapillary lens, the inside diameter of the capillaries may be made smaller in the area closer to the center of the polycapillary lens.

The foregoing polycapillary lens may be configured to convert radiation or a particle beam, input from the point radiation source into the one end face, into a parallel beam and output the parallel beam from the other end face. Or, the forgoing polycapillary lens may be configured to convert parallel radiation or a parallel particle beam, input into the one end face, into a focusing beam and output the focusing beam from the other end face. Or, the foregoing polycapillary lens may be configured to convert radiation or a particle beam, input from the point radiation source into the one end face, into a focusing beam and output the focusing beam from the other end face.

### INDUSTRIAL APPLICABILITY

The present invention is applicable as polycapillary lenses capable of realizing characteristics suitable for applications.

### REFERENCE SIGNS LIST

10A, 10B, 10C, 10D—polycapillary lens, 12—X-ray source, 14—one end face (input end face), 16—other end face (output end face), 18a, 18b—capillary, 20, 24, 25, 28, 29—preform, 21A, 21B, 26A, 26B capillary assembly, 22a, 22b—hollow tube, A1 to A5—area, B—central axis, D—focal point, La, Lb—inside diameter of capillary, XR1, XR3, XR5—input X-ray, XR2, XR4, XR6—output X-ray.

1. A polycapillary lens having a plurality of capillaries extending from one end face to the other end face and configured to guide radiation or a particle beam input into the one end face, to the other end face, wherein
in a plane intersecting with a guide direction of the radiation or the particle beam, there are a plurality of concentric areas different in inside diameter of the capillaries from each other.

2. The polycapillary lens according to claim 1, comprising a plurality of capillary assemblies each of which includes a plurality of bundled hollow tubes forming the respective capillaries and which are two-dimensionally arranged in the plane, wherein
cross-sectional shapes and sizes of the capillary assemblies in the plane are equal to each other between at least two neighboring areas out of the plurality of areas.

3. The polycapillary lens according to claim 2, wherein the cross-sectional shapes of the capillary assemblies in the plane are regular hexagon or square.

4. The polycapillary lens according to claim 1, wherein the inside diameter of the capillaries is larger in the area closer to a center of the polycapillary lens.

5. The polycapillary lens according to claim 1, wherein the inside diameter of the capillaries is smaller in the area closer to a center of the polycapillary lens.

6. A polycapillary lens having a plurality of capillaries extending from one end face to the other end face and configured to guide radiation or a particle beam input into the one end face, to the other end face, wherein
in a plane intersecting with a guide direction of the radiation or the particle beam, an inside diameter of the capillaries in a first area is different from an inside diameter of the capillaries in a second area surrounding the first area.

7. The polycapillary lens according to claim 1, wherein the polycapillary lens is configured to convert the radiation or the particle beam, input from a point radiation source into the one end face, into a parallel beam and output the parallel beam from the other end face.

8. The polycapillary lens according to claim 1, wherein the polycapillary lens is configured to convert the parallel radiation or the parallel particle beam, input into the one end face, into a focusing beam and output the focusing beam from the other end face.

9. The polycapillary lens according to claim 1, wherein the polycapillary lens is configured to convert the radiation or the particle beam, input from a point radiation source into the one end face, into a focusing beam and output the focusing beam from the other end face.

10. The polycapillary lens according to claim 6, wherein the polycapillary lens is configured to convert the radiation or the particle beam, input from a point radiation source into the one end face, into a parallel beam and output the parallel beam from the other end face.

11. The polycapillary lens according to claim 6, wherein the polycapillary lens is configured to convert the parallel radiation or the parallel particle beam, input into the one end face, into a focusing beam and output the focusing beam from the other end face.

12. The polycapillary lens according to claim 6, wherein the polycapillary lens is configured to convert the radiation or the particle beam, input from a point radiation source into the one end face, into a focusing beam and output the focusing beam from the other end face.
